(19) United States
(12) Patent Application Publication
(10) Pub. No.: US 2015/0112902 A1
(43) Pub. Date: Apr. 23, 2015

(54) INFORMATION PROCESSING DEVICE

(71) Applicant: Preferred Infrastructure, Inc., Tokyo (JP)

(72) Inventors: Yuya Unno, Tokyo (JP); Kei Akita, Tokyo (JP); Yuichiro Imamura, Tokyo (JP); Soshi Watanabe, Tokyo (JP); Masaaki Fukuda, Tokyo (JP)

(73) Assignee: PREFERRED INFRASTRUCTURE, INC., Tokyo (JP)

(21) Appl. No.: 14/515,336

(22) Filed: Oct. 15, 2014

(30) Foreign Application Priority Data
Oct. 17, 2013 (JP) 2013-216382

(51) Int. Cl. G06N 99/00

(52) U.S. Cl. CPC G06N 99/005
USPC 706/12

(57) ABSTRACT

The information processing device according to one embodiment comprises a storage device for storing model information generated through execution of machine learning while employing learning data, the model information including feature information and weighting information associated with the feature information, for each of a plurality of labels; and a display control device for displaying the feature information included in the model information for at least one label among the plurality of labels on a display device, on the basis of the weighting information associated with the feature information.

### CROSS-REFERENCE TO RELATED APPLICATIONS

This application is based upon and claims priority under 35 U.S.C. §119 to Japanese Patent Application No. 2013-216382, filed Oct. 17, 2013, entitled “Information Processing Device”, the entire contents of which are hereby incorporated herein by reference.

### FIELD

The disclosed technology relates to an information processing device for executing information processing in relation to analysis of unstructured data.

### BACKGROUND

One known information processing device for executing information processing in relation to analysis of unstructured data is that disclosed in Japanese Laid-Open Patent Application 2013-101415, which is hereby incorporated herein by reference in its entirety. The information processing device disclosed in this document employs commodity web pages as unstructured data, and is adapted to calculate a degree of similarity between a first commodity web page and a second commodity web page, on the basis of feature information respectively contained in these commodity web pages, to thereby determine whether these commodity web pages deal with similar commodities.

However, the information processing device according to the prior art disclosed in the aforementioned document presents the user only with the results of analysis of unstructured data (commodity web pages), and cannot present to the user the manner in which the results have been affected by feature information included in the unstructured data.

### SUMMARY

The various embodiments of the disclosed technology provide an information processing device whereby a user may be presented with the effects of feature information included in unstructured data, on the results obtained through analysis of the unstructured data.

The information processing device according to an aspect of the disclosed technology comprises a storage device for storing model information generated through execution of machine learning while employing learning data, the model information including feature information and weighting information associated with the feature information, for each of a plurality of labels; and a display control device for displaying the feature information included in the model information for at least one label among the plurality of labels on a display device, on the basis of the weighting information associated with the feature information.

The computer program product according to an aspect of the disclosed technology is configured to allow a computer to operate as: a storage device for storing model information generated through execution of machine learning while employing learning data, the model information including feature information and weighting information associated with the feature information, for each of a plurality of labels; and a display control device for displaying the feature information included in the model information for at least one label among the plurality of labels on a display device, on the basis of the weighting information associated with the feature information.

The various embodiments of the disclosed technology provide an information processing device for presenting to a user the effects of feature information included in unstructured data, on the results obtained through analysis of the unstructured data in question.

### BRIEF DESCRIPTION OF THE DRAWINGS

FIG. 1 is a block diagram showing the configuration of an information processing system including the information processing device according to an embodiment of the disclosed technology.

FIG. 2 is a block diagram of the architecture of a terminal device 30 included in the information processing system shown in FIG. 1.

FIG. 3 is a block diagram showing a specific example of functionality of a server device 10 according to an embodiment of the disclosed technology.

FIG. 4 is a flow chart showing a specific example of operation carried out during a learning process by the information processing system shown in FIG. 1.

FIG. 5 is a diagram showing a specific example of learning data handled by an information processing system including the information processing device according to an embodiment of the disclosed technology.

FIG. 6 is a model diagram showing conceptually a specific example of morphological analysis of the learning data shown in FIG. 5.

FIG. 7 is a flow chart showing a specific example of operation carried out during an analysis process by the information processing system shown in FIG. 1.

FIG. 8 is a model diagram showing a specific example of a screen displayed by a display device, as the result of display control performed by an information processing system including the information processing device according to an embodiment of the disclosed technology.

FIG. 9 is a model diagram showing a specific example of another screen displayed by a display device, as the result of display control performed by an information processing system including the information processing device according to an embodiment of the disclosed technology.

### DETAILED DESCRIPTION

Various embodiments of the disclosed technology shall be described below with reference to the accompanying drawings. Like constituent elements in the drawings are assigned identical reference numbers.

Firstly, by way of a preferred embodiment, there will be described an embodiment in which a terminal device accesses a server device through a communications link, prompts the server device to perform an analysis of unstructured data, and displays the results of the analysis on a display device connected to the terminal device. Specifically, the terminal device is provided by the server device with a service relating to analysis of unstructured data (hereinafter termed an “analysis service”).

As one example, the analysis service provided to the terminal device by the server device shall be described in terms of a service for determining which age strata, from among teens, people in their 20's, people in their 30's, people in their 40's, and people in their 50's, created text posted on a bulletin board on the internet.

### 1. Overview

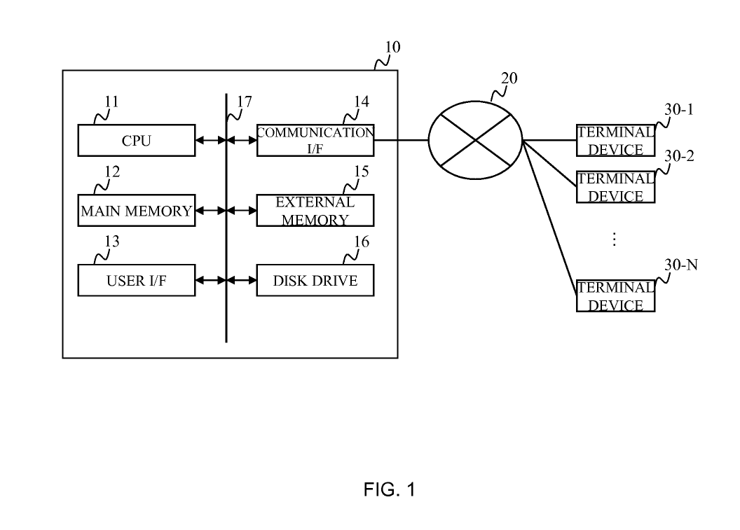

FIG. 1 is a block diagram showing the configuration of an information processing system including the information processing device according to an embodiment of the disclosed technology. The information processing system includes a server device 10, and a plurality of terminal devices 30-1, 30-2, . . . 30-N (sometimes referred to collectively as “terminal devices 30”) having communications functions. The server device 10 and the terminal devices are connected through a communications network (communications link) 20, such as the internet or the like.

Using the terminal devices 30, users are provided by the server device 10 with analysis services via the communications network 20.

### 2. Configuration of Server Device 10

The server device 10 includes a CPU 11, a main memory 12, a user interface (I/F) 13, a communications interface (I/F) 14, an external memory 15, and a disk drive 16, these constituent elements being electrically interconnected by a bus 17. The CPU 11 loads an operating system, a program for accomplishing functions relating to an analysis service, and the like, into the main memory 12 from the external memory 15, and executes commands contained in the loaded programs. The main memory 12 is used to hold a program for execution by the CPU 11, and is constituted, for example, by DRAM.

The user I/F 13 includes, for example, an information input device, such as a mouse or keyboard, for accepting input from an operator, and an information output device, such as a liquid crystal display, for outputting results of computations by the CPU 11. The communications I/F 14 is implemented in the form of hardware, firmware, a TCP/IP driver, PPP driver, or other such communications software, or a combination of these, and is constituted to be able to communicate with the terminal devices 30 via the communications network 20.

The external memory 15 is constituted, for example, by a magnetic disk drive, and stores various programs, such as a program for accomplishing functions relating to an analysis service, and the like. The external memory 15 is also able to store data of various kinds used in these programs.

The disk drive 16 reads data contained on various types of storage media such as CD-ROM, DVD-ROM, DVD-R, and the like, as well as writing data to these storage media.

According to one embodiment, the server device 10 can be a web server for managing a website that includes a plurality of web pages having a hierarchical structure, and is able to provide analysis services to the terminal devices 30. Browser software furnished to the terminal devices 30 is able to acquire from the server device 10 HTML data for displaying web pages, analyze the acquired HTML data, and present the web pages in question to users of the terminal devices 30. HTML data for displaying web pages can also be stored in the external memory. HTML data is composed of HTML documents described in a markup language such as HTML, and tags can be utilized to associate various images with these HTML documents. Programs described by script languages, such as ActionScript or JavaScript™, can be embedded into HTML documents.

In this way, the server device 10 manages a website for providing analysis services, and can provide users with analysis services by distributing web pages that make up the website, in response to requests from the terminal devices 30.

### 3. Configuration of Terminal Devices 30

In one embodiment, the terminal devices 30 are information processing devices of any type able to display in a web browser the web pages of a website acquired from the server device 10, including, for example, mobile phones, smartphones, game consoles, PCs, touchpads, and e-book readers; however, there is no limitation to these.

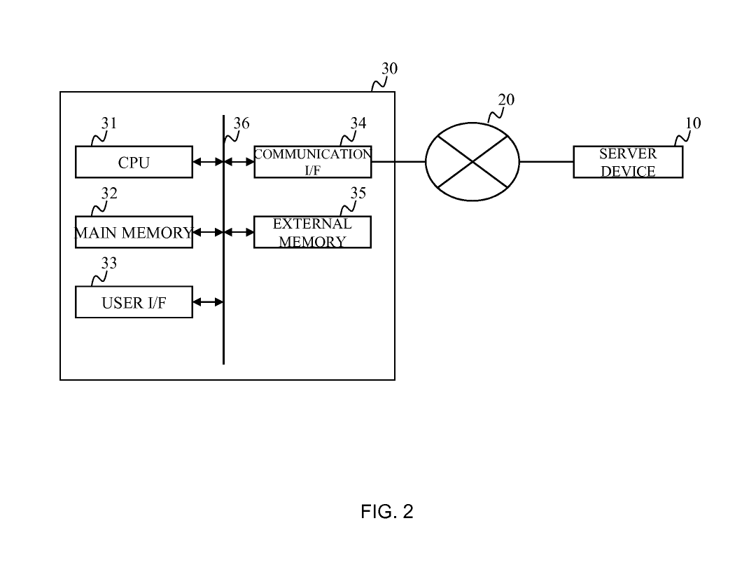

The architecture of the terminal devices 30 will be described with reference to FIG. 2. FIG. 2 is a block diagram of the architecture of the terminal devices 30 included in the information processing system shown in FIG. 1. As shown in the drawing, each of the terminal devices 30 includes a CPU 31, a main memory 32, a user interface (I/F) 33, a communications interface (I/F) 34, and an external memory 35, these constituent elements being electrically interconnected by a bus 36.

The CPU 31 loads various programs such as an operating system and the like, into the main memory 32 from the external memory 35, and executes commands contained in the loaded programs. The main memory 32 is used to hold a program for execution by the CPU 31, and is constituted, for example, by DRAM.

The user I/F 33 includes, for example, an information input device, such as a touch panel, keyboard, button, or mouse, for accepting input from a user; and an information output device, such as a liquid crystal display, for outputting results of computations by the CPU 31. The communications I/F 34 is implemented in the form of hardware, firmware, a TCP/IP driver, PPP driver, or other such communications software, or a combination of these, and is constituted to be able to communicate with the server device 10 via the communications network 20.

The external memory 35 is constituted, for example, by a magnetic disk drive, flash memory, or the like, and stores various programs, such as the operating system.

The terminal devices 30 having the above architecture are furnished, for example, with a browser software for interpretation and screen display of files in HTML format (HTML data). HTML data acquired from the server device 10 is interpreted by a function of this browser software, which is then able to display web pages corresponding to the received HTML data. The terminal devices 30 are moreover furnished with plug-in software (e.g., Flash Player from Adobe Systems; Flash is a registered trademark) incorporated within the browser software, and when a file in SWF format embedded in HTML data is acquired from the server device 10, the SWF format file can be executed by the browser software and the plug-in software.

Once a file in HTML format (HTML data) has been interpreted by one of the terminal devices 30, animations or icons for control purposes, specified in the file, are displayed on the screen of the terminal device 30. Using the input interface (e.g., a touchscreen or button) of the terminal device 30, the user is able to input a command to start an analysis service. The command input by the user is transmitted to the server device 10 through a browser, or a function of a platform such as ngCore™ or the like, on the terminal device 30.

### 4. Functions of Server Device 10

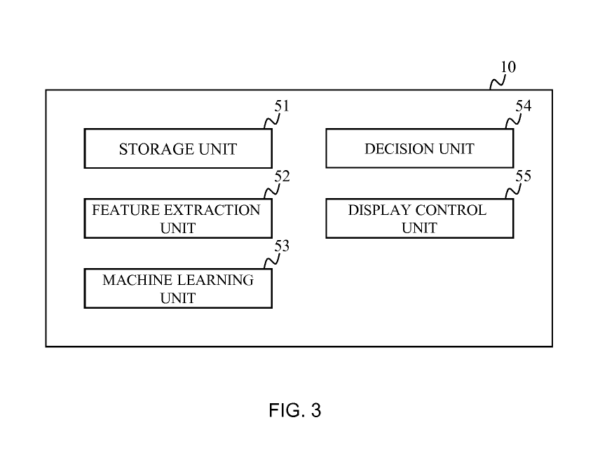

Next, the functions of the server device 10 which are accomplished through the constitutional elements shown in FIG. 1 will be described with reference to FIG. 3. FIG. 3 is a block diagram showing a specific example of functionality of the server device 10 according to an embodiment of the disclosed technology.

As shown in FIG. 3, the server device 10 includes a storage unit 51, a feature extraction unit 52, a machine learning unit 53, a decision unit 54, and a display control unit 55.

4-1. Storage Unit

The storage unit 51 stores information of various kinds for use in analysis services. As discussed below, the storage unit 51 stores information of various kinds, for example, learning data, data to be analyzed, feature information extracted from this data, model information, and the like. It is possible for the information stored in this storage unit 51 to be updated, as appropriate.

4-2. Feature Extraction Unit 52

The feature extraction unit 52, through execution of feature extraction on unstructured data (here, morphological analysis is described as one example), extracts feature information (feature words, feature vectors) from unstructured data. The feature information extracted in this manner may be stored in the storage unit 51.

4-3 Machine Learning Unit 53

The machine learning unit 53 executes machine learning using the unstructured data and the feature information stored in the storage unit 51, to thereby generate model information. This model information includes, for each of a plurality of labels, feature information, and weighting information associated with this model information. The model information so generated may be stored in the storage unit 51.

4-4. Decision Unit 54

The decision unit 54 uses the model data and data targeted for analysis (data to be analyzed) stored in the storage unit 51 to decide the age stratum of the person who created the data targeted for analysis, within an age range from teens to people in their 50's.

4-5. Display Control Unit 55

The display control unit 55, on the basis of the weighting information associated with this feature information, displays the feature information included in the model information for the plurality of labels, on at least the display device included in the user I/F 13 of the server device 10, and/or the user I/F 33 of the terminal device 30.

Specifically, the display control unit 55 can display feature information according to at least a first display mode and a second display mode. That is, in the first display mode, the display control unit 55 displays on the display device feature information contained in data to be analyzed, which feature information is identical to feature information included in the model information, doing so on the basis of the weighting information associated with this feature information. In the second display mode, the display control unit 55 displays on the display device feature information contained in the model information, doing so according to an order which has been determined on the basis of the size of the weighting information that has been associated with this feature information.

### 5. Operations Performed During Provision of Analysis Service

The operations performed by the information processing system shown in FIG. 1 include at least a learning process and an analysis process. The learning process is a process in which learning data (unstructured data employed in generating model information; in this instance, numerous samples of text created respectively by people belonging to several age strata, for example, strata ranging from teen to people in their 50's) is used to execute machine learning, to thereby generate model information. The analysis process is a process in which data to be analyzed (unstructured data targeted for analysis; in this instance, text for which the creator's age stratum, for example, one ranging from teens to people in their 50's, is uncertain) and model information generated by machine learning are used to decide the age stratum of the person who created the data to be analyzed.

5-1. Learning Process

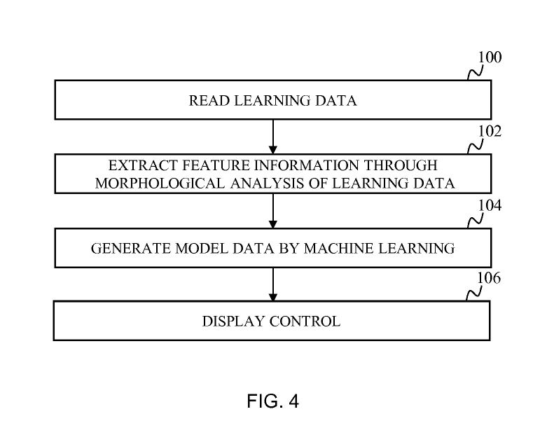

FIG. 4 is a flow chart showing a specific example of operation carried out during a learning process by the information processing system shown in FIG. 1.

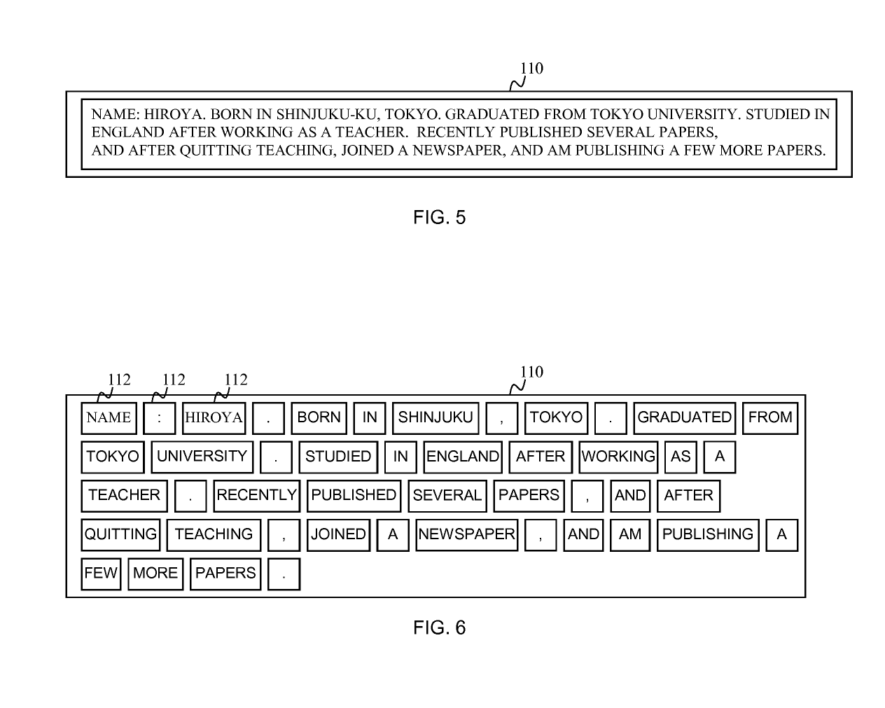

In Step (hereinafter “ST”) 100, the server 10 reads out learning data stored in the storage unit 51. FIG. 5 is a model diagram showing conceptually a specific example of learning data handled by an information processing system including the information processing device according to an embodiment of the disclosed technology.

The read out learning data includes numerous samples of text (unstructured data) created by people respectively belonging to age strata ranging from teens to people in their 50's. The age stratum of the person who created each set of learning data is previously known to the server device 10, and information indicating the age strata of the persons who created the data is stored in the storage unit 51, in associated form with the learning data. FIG. 5 shows, by way of an example of learning data, learning data 110 including text created by a person in his 20's.

In ST102, feature information (feature words) is extracted through execution of morphological analysis on respective sets of read out learning data by the feature extraction unit 52. FIG. 6 is a model diagram showing conceptually a specific example of morphological analysis of the learning data shown in FIG. 5. FIG. 6 shows a large amount of feature information 112 extracted from the learning data 110 (in FIG. 6, for simplicity, only three items of the learning data have been assigned reference 112). In this instance, numerous words have been extracted as feature information. These words include nouns, adjectives, verbs, particles, and so on. It is possible to utilize not only the format of morphological analysis shown in FIG. 6, but also various other types of morphological analysis.

The extracted feature information is associated with information indicating the age associated with the feature information, and stored in the storage unit 51.

In ST104, the feature information extracted from each set of learning data (and the information indicating age) is used by the machine learning unit 53 to execute machine learning. Model information is generated by this machine learning.

The model information includes the feature information, and the weighting information associated with the model information, for each of the plurality of labels. Specifically, the model information includes, for the label of “teen” for example, a plurality of items of feature information (feature information A1-AX, where X is a natural number) extracted from a large quantity of learning data associated with teens, as well as weighting information associated with each item of feature information, as shown in Table 1 below. In this instance, a larger numerical value of the weighting information means a higher probability, frequency, or chance that the feature information associated with the weighting information would be utilized by the teen age stratum, whereas a smaller numerical value means a lower probability, frequency, or chance that the feature information associated with the weighting information would be utilized the teen age stratum.

TABLE 1

| Label | Feature information | Weighting information |
|---|---|---|
| Teen | Feature information A1 | 0.432334 |
| | Feature information A2 | −0.192385 |
| | Feature information A3 | −0.234572 |
| | Feature information A4 | 0.392110 |
| | Feature information A5 | 0.388765 |
| | • | • |
| | • | • |
| | • | • |
| | Feature information AX | −0.113532 |

For the label of “20's” as well, the model information includes a plurality of items of feature information (feature information A1-AX, where X is a natural number) extracted from a large quantity of learning data associated with people in their 20's, as well as weighting information associated with each item of feature information, as shown in Table 2 below.

TABLE 2

| Label | Feature information | Weighting information |
|---|---|---|
| 20's | Feature information A1 | 0.133445 |
| | Feature information A2 | −0.334567 |
| | Feature information A3 | −0.456278 |
| | Feature information A4 | 0.578823 |
| | Feature information A5 | 0.112308 |
| | • | • |
| | • | • |
| | • | • |
| | Feature information AX | −0.100343 |

Likewise, for the labels of “30's,” “40's,” and “50's” as well, the model information respectively includes a plurality of items of feature information, as well as weighting information associated with each item of feature information, as shown respectively in Tables 3, 4, and 5 below. The model information generated in this manner is stored in the storage unit 51.

TABLE 3

| Label | Feature information | Weighting information |
|---|---|---|
| 30's | Feature information A1 | −0.124456 |
| | Feature information A2 | 0.478678 |
| | Feature information A3 | −0.579972 |
| | Feature information A4 | 0.788972 |
| | Feature information A5 | 0.034288 |
| | • | • |
| | • | • |
| | • | • |
| | Feature information AX | 0.232210 |

TABLE 4

| Label | Feature information | Weighting information |
|---|---|---|
| 40's | Feature information A1 | −0.225431 |
| | Feature information A2 | 0.498213 |
| | Feature information A3 | −0.872112 |
| | Feature information A4 | 0.882013 |
| | Feature information A5 | −0.232134 |
| | • | • |
| | • | • |
| | • | • |
| | Feature information AX | 0.478472 |

TABLE 5

| Label | Feature information | Weighting information |
|---|---|---|
| 50's | Feature information A1 | −0.403210 |
| | Feature information A2 | 0.781213 |
| | Feature information A3 | −0.88021 |
| | Feature information A4 | 0.890012 |
| | Feature information A5 | −0.401223 |
| | • | • |
| | • | • |
| | • | • |
| | Feature information AX | 0.492332 |

Next, in ST106, for at least one of the plurality of labels, control in order to display the feature information on the display device is performed by the display control unit 55, on the basis of the weighting information association with a plurality of items of feature information included in the model information. Specifically, for the label of “teen” for example, the plurality of items of feature information included in the model information (see Table 1) is displayed on the display device in the form of a ranking chart as shown in the following Table 6 and Table 7 (second display mode).

As shown in FIG. 6, the twenty items of feature information having the largest weighting information are displayed according to a prescribed order (i.e. descending order), on the basis of the magnitude of the weighting information. In this instance, feature information ranked at high positions represents feature information that, in cases in which the feature information in question is included in data to be analyzed, will contribute to a prediction that the data to be analyzed was created by a teen.

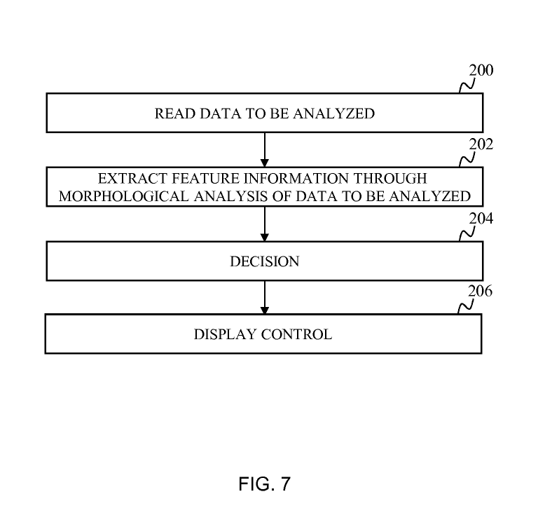

As shown in FIG. 7, the twenty items of feature information having the smallest weighting information are displayed according to a prescribed order (i.e. ascending order), on the basis of the magnitude of the weighting information. In this instance, feature information ranked at high positions represents feature information that, in cases in which the feature information in question is included in data to be analyzed, will contribute to a prediction that the data to be analyzed was not created by teen.

TABLE 6
Conditions for prediction of teen

| Position | Feature information | Weighting information |
|---|---|---|
| 1 | high-school | 0.498615 |
| 2 | forever | 0.447935 |
| 3 | university | 0.390764 |
| 4 | high | 0.369148 |
| 5 | examination | 0.308437 |
| 6 | student | 0.293609 |
| 7 | game | 0.290195 |
| 8 | school | 0.223546 |
| 9 | club | 0.205200 |
| 10 | acceptance | 0.198261 |
| 11 | homework | 0.182310 |
| 12 | cram | 0.175825 |
| 13 | break | 0.171048 |
| 14 | pixiv.net | 0.158487 |
| 15 | ameba.jp | 0.156319 |
| 16 | Uuu | 0.154825 |
| 17 | class | 0.152695 |
| 18 | girls | 0.149667 |
| 19 | study | 0.148230 |
| 20 | Score | 0.144306 |

TABLE 7
Conditions for prediction of non-teen

| Position | Feature information | Weighting information |
|---|---|---|
| 1 | Sake | −0.238535 |
| 2 | single | −0.223384 |
| 3 | marriage | −0.200131 |
| 4 | Job | −0.193299 |
| 5 | Shift | −0.180439 |
| 6 | Drink | −0.179261 |
| 7 | degree-holder | −0.173052 |
| 8 | graduate | −0.171691 |
| 9 | worker | −0.158043 |
| 10 | Child | −0.157764 |
| 11 | work | −0.153710 |
| 12 | cafe | −0.153078 |
| 13 | age | −0.152589 |
| 14 | drinking | −0.151443 |
| 15 | mellow | −0.150067 |
| 16 | kids | −0.149731 |
| 17 | unemployed | −0.148704 |
| 18 | seminar | −0.148115 |
| 19 | 198 | −0.143792 |
| 20 | company | −0.143306 |

For the respective labels of “20's” to “50's” as well, the plurality of items of feature information included in the model information (see the respective Tables 2-5) may be displayed by the display device as ranking charts similar to those shown in Table 6 and Table 7.

As another embodiment, instead of a ranking display as shown by way of example in Table 6 and Table 7, or together with such a ranking display, the plurality of items of feature information may be displayed in a graph such as a pie graph, bar graph, or the like employing weighting information associated with the feature information.

Additionally, the plurality of items of feature information can be displayed in a mode that is determined on the basis of the magnitude of the weighting information associated with the feature information. Such modes may include one or more modes selected from size, color, shading, pattern, shape, brightness, font, and design. Specific examples of these modes shall be described below.

5-2. Analysis Process

FIG. 7 is a flow chart showing a specific example of operations carried out during an analysis process by the information processing system shown in FIG. 1.

In ST200, text (unstructured data) for which the creator's age stratum is uncertain, for example, text posted on a bulletin board on the internet, is read from the storage unit 51 as data to be analyzed. In ST202, feature information is extracted through morphological analysis performed on the data to be analyzed by the feature extraction unit 52. The morphological analysis performed in this instance is the same as that performed in ST102 in FIG. 4 discussed previously.

Next, in ST204, the decision unit 54 decides which, of age strata ranging from teens to people in their 50's, the creator of the data to be analyzed belongs to. Specifically, of the plurality of items of feature information that were extracted from the data to be analyzed, a search is first performed to find feature information identical to the plurality of items of feature information included in the model information under the “teen” label. Next, for all of the found feature information, the sum of the associated weighting information is calculated. Let this sum be a sum X1 for “teen.” A similar search and calculation are respectively performed for the “20's” to “50's” strata. In so doing, sums X2-X5 for the “20's” to “50's” strata are obtained. The age corresponding to the largest numerical value among sum X1 to sum X5 will be the result of the decision. For example, in the event that the sum X2 is the largest, it will be decided that the data to be analyzed was created by a person in their 20's.

Next, in ST206, the display control unit 55 performs control in such a way that feature information which is included in the data to be analyzed, and which is identical to feature information included in the model information, is displayed by the display device 55, on the basis of the weighting information associated with this feature information.

Firstly, the numerous items of feature information extracted from the data to be analyzed in ST202 discussed previously are read out from the storage unit 51. These numerous items of feature information are first searched to find feature information identical to the feature information included in the model information under the “teen” label. A search is also made for the weighting information associated with each of the found items of feature information. In so doing, weighting information for “teen” is obtained for each of the numerous items of feature information extracted from the data to be analyzed.

By performing similar searches, weighting information for “20's” to “50's” strata is obtained, for each of the numerous items of feature information extracted from the data to be analyzed.

Next, the numerous items of feature information extracted from the data to be analyzed are displayed on the basis of the magnitude of the respective weighting information for the “20's” to “50's” strata (first display mode).

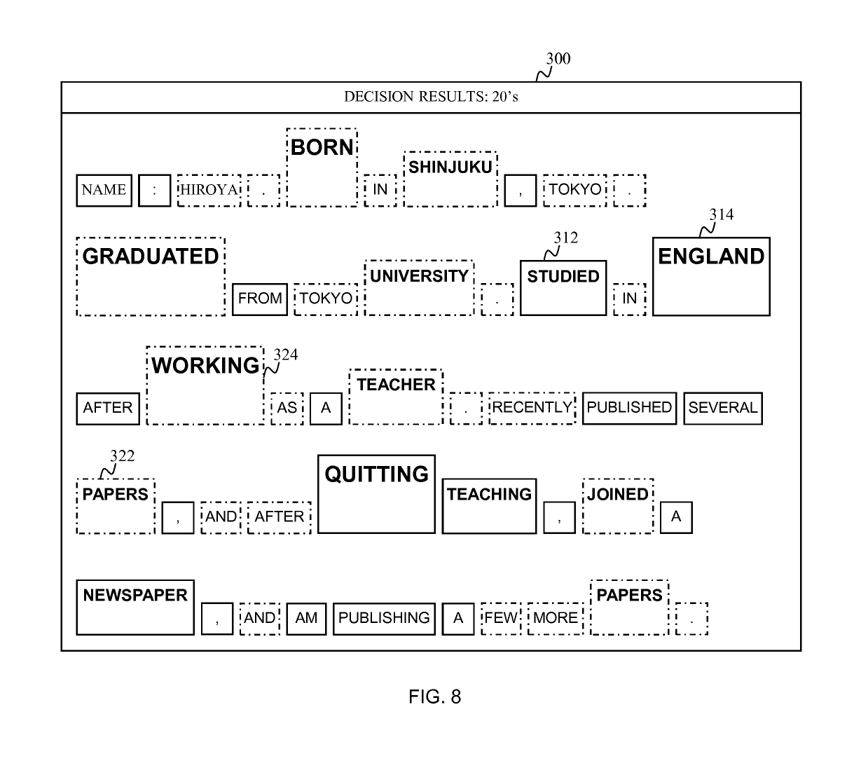

FIG. 8 is a model diagram showing a specific example of a screen displayed by a display device, as the result of display control performed by an information processing system including the information processing device according to an embodiment of the disclosed technology (in FIG. 8, merely in order to simplify the description, data to be analyzed 300 identical to the learning data 110 shown in FIG. 5 is shown as the data to be analyzed; in actual practice, however, cases in which the learning data and the data to be analyzed are identical are rare.)

FIG. 8 shows an example in which numerous items of feature information extracted from the data to be analyzed are displayed on the basis of the magnitude of weighting information for the “20's” stratum. As discussed previously, the decision unit 54 has decided that, of the “teens” to “50's” strata, the creator of the data analyzed belongs to the “20's” stratum.

In the screen shown in FIG. 8, as one example, feature information that, of numerous items of feature information, are items that contributed “affirmatively” to the “20's” stratum decision result, i.e., information having larger weighting information, are bordered by rectangles drawn with solid lines, whereas items of feature information that contributed “negatively” to the “20's” stratum decision result, i.e., information having smaller weighting information, are bordered by rectangles drawn with dot-and-dash lines.

Further, of the feature information that contributed “affirmatively” (information having weighting information of 0 or greater), for example, feature information 312 and 314, the feature information 314, which has the larger weighting information, is displayed such that the feature information itself is larger as compared with the feature information 312 having the smaller weighting information, and furthermore a larger rectangle is displayed bordering the feature information.

Conversely, of the feature information that contributed “negatively” (information having weighting information of less than 0), for example, feature information 322 and 324, the feature information 324, which has the smaller weighting information, is displayed larger than the feature information 322 having the greater weighting information.

In so doing, the user can easily discern whether each item of feature information (i) contributed affirmatively or negatively to the decision result; and (ii) the extent of the contribution of each item of feature information.

In FIG. 8, as a specific example relating to display of feature information on the basis of the magnitude of the weighting information of the feature information in question, there is shown an example in which both the size of the feature information itself, and the size of the rectangle bordering the feature information, are displayed on the basis of the associated weighting information; however, it would be acceptable to display either the size of the feature information itself, or the size of the rectangle bordering the feature information, but not both, on the basis of the associated weighting information.

FIG. 8 shows an example in which, in relation to the display of feature information according to a mode determined on the basis of the magnitude of the weighting information associated with the feature information, the mode is “size.”

Modes for display of feature information on the basis of the magnitude of weighting information may include one or more modes selected from size, color, shading, pattern, shape, brightness, font, sound, words, and design.

In the event that “color” is employed as a mode, for example, feature information having larger weighting information may be displayed in colors having lower saturation, and feature information having smaller weighting information may be displayed in colors having more saturation (or by the reverse process).

In the event that “shading” is employed as a mode, for example, feature information having larger weighting information may be displayed in darker colors, and feature information having smaller weighting information may be displayed in lighter colors (or by the reverse process).

In the event that “pattern” is employed as a mode, for example, feature information having larger weighting information may be displayed with a more complex pattern, and feature information having smaller weighting information may be displayed with a more simple pattern (or by the reverse process).

In the event that “shape” is employed as a mode, for example, feature information having larger weighting information may be displayed with a more complex shape, and feature information having smaller weighting information may be displayed with a more simple shape (or by the reverse process).

In the event that “brightness” is employed as a mode, for example, feature information having larger weighting information may be displayed at higher brightness, and feature information having smaller weighting information may be displayed at lower brightness (or by the reverse process).

In the event that “font” is employed as a mode, for example, feature information having larger weighting information may be displayed with a more complex font, and feature information having smaller weighting information may be displayed with a more simple font (or by the reverse process).

In the event that “design” is employed as a mode, for example, feature information having larger weighting information may be displayed with a more complex design, and feature information having smaller weighting information may be displayed with a more simple design (or by the reverse process).

It is possible for the modes mentioned above to be employed in combination.

While FIG. 8 shows an example in which numerous items of feature information extracted from the data to be analyzed are displayed on the basis of the magnitude of the weighting information for the “20's” stratum, these items of feature information may be displayed on the basis of magnitude of the weighting information for the “teen” and the “30's” to “50's” strata.

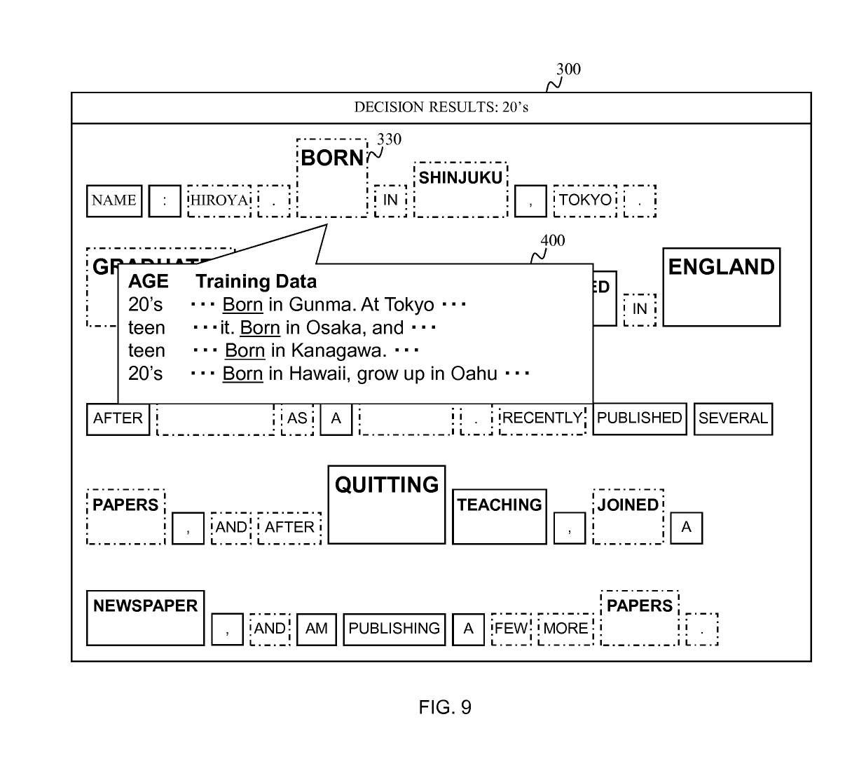

As yet another embodiment, as shown in FIG. 9, when a user has selected displayed feature information (with a pointer or the like), there may be displayed an index showing how the selected feature information was employed within the learning data. FIG. 9 shows display of an index 400 corresponding to feature information 330, which appears when the user has selected the feature information 330 in question, for example. This index 400 shows, for example, the manner in which particular feature information appeared in particular text, in text created by people of different ages, in the learning data that was employed to generate the model.

Hereinabove, as one example of an analysis service, there has been described a service for deciding whether text posted on a bulletin board on the internet was created by a person belonging to an age stratum ranging from teens to people in their 20's, 30's, 40's, and 50's; however, it is possible for various types of analysis services to be utilized.

For example, it would be possible to utilize a service for analyzing whether verbal or written contacts from a customer represents complaints, queries, or positive feedback. In this case, employing contacts (either verbal or written) fielded from customers as learning data, words extracted from speech data or text data relating to contacts may be employed as feature information in the model information, and labels such as “complaint,” “query,” “positive feedback,” and the like may be employed as labels in the model information. In other respects, information and processes similar to those discussed above may be employed.

As yet another example, it would be possible to utilize a service for deciding whether newspaper articles or broadcast news relate to any of fields such as international, politics, arts, sports, science, and the like. In this case, employing published newspaper articles or broadcast news as learning data, words extracted from text data pertaining to newspaper articles or speech data pertaining to broadcast news may be employed as feature information in the model information, and labels such as “international”, “politics”, “arts”, “sports”, “science”, and the like may be employed as labels in the model information. In other respects, information and processes similar to those discussed above may be employed.

As yet another example, it would be possible to utilize a service for predicting whether or not a newly developed drug disturbs coronary function. In this case, the structure and chemical properties (hydrophilicity, acidity, basicity, and the like) of a compound contained in a drug could be used as feature information in the model information, and “disturbs coronary function” and “does not disturb coronary function” employed as labels in the model information.

In the aforedescribed embodiments, terminal devices are provided with an analysis service by accessing a server device (in this embodiment, the server device corresponds to the “information processing device” indicated in the Claims, and display devices having a wired connection to the server device and/or terminal devices, and/or display devices furnished to terminal devices themselves, correspond to the “display device” indicated in the Claims.

In yet another embodiment, a terminal device may provide an analysis service to a user without accessing a server device, simply through operation according to an installed program. In this case, the terminal device can be one having functions identical or equivalent to the functions described in FIG. 3 (in this embodiment, the terminal device corresponds to the “information processing device” indicated in the Claims, and a display device having a wired connection to the terminal device, and/or a display device furnished to a terminal device itself, correspond to the “display device” indicated in the Claims).

The processes and procedures described in the present Description have been described solely for illustrative purposes in the embodiments, and may be accomplished through software, hardware, and combinations thereof. In specific terms, the processes and procedures described in the present Description may be accomplished through implementation of logic corresponding to the processes in question, in media such as integrated circuits, volatile memory, non-volatile memory, magnetic disks, optical storage, and the like. It is possible for the processes and procedures described in the present Description to be implemented as a computer program for the processes/procedures, which is executed by any of various kinds of computer.

While the processes and procedures described in the present Description have been described as being executed by a single device, software, component, or module, such processes and procedures can be executed by multiple devices, multiple software applications, multiple components, and/or multiple modules. While the data, tables, and databases described in the present Description have been described as being held in a single memory, such data, tables, and databases may be held in distributed fashion among multiple memories or multiple devices. Further, the software and hardware elements described in the present Description may be accomplished with fewer constituent elements through integration, or accomplished with a greater number of constituent elements through disaggregation.

1. An information processing device comprising:
a storage device for storing model information generated through execution of machine learning while employing learning data, the model information including feature information and weighting information associated with the feature information, for each of a plurality of labels; and
a display control device for displaying the feature information included in the model information for at least one label among the plurality of labels on a display device, on the basis of the weighting information associated with the feature information, wherein the display control device displays feature information among feature information included in data to be analyzed, the displayed feature information being identical to the feature information included in the model information, and wherein the display control device displays the feature information on the basis of the magnitude of the weighting information associated with the feature information.

2. (canceled)

3. The information processing device according to claim 1,
wherein the display control device displays the feature information included in the model information on the basis of the magnitude of the weighting information associated with the feature information.

4. The information processing device according to claim 1,
wherein the display control device displays the feature information in a mode which is determined on the basis of the magnitude of the weighting information associated with the feature information.

5. The information processing device according to claim 4,
wherein the mode includes at least one mode of size, color, shading, pattern, shape, brightness, font, and design.

6. The information processing device according to claim 3,
wherein the display control device displays the feature information included in the model information according to an order which is determined on the basis of the magnitude of the weighting information associated with the feature information.

7. A terminal device comprising the information processing device according to claim 1.

8. A server device comprising the information processing device according to claim 1.

9. A computer program product configured to allow a computer to operate as:
a storage device for storing model information generated through execution of machine learning while employing learning data, the model information including feature information and weighting information associated with the feature information, for each of a plurality of labels; and
a display control device for displaying the feature information included in the model information for at least one label among the plurality of labels on a display device, on the basis of the weighting information associated with the feature information, wherein the display control device displays feature information among feature information included in data to be analyzed, the displayed feature information being identical to the feature information included in the model information, and wherein the display control device displays the feature information on the basis of the magnitude of the weighting information associated with the feature information.
